(19) United States
(12) Patent Application Publication
(10) Pub. No.: US 2026/0056559 A1
(43) Pub. Date: Feb. 26, 2026

(54) SYSTEM

(71) Applicant: SoftBank Group Corp., Tokyo (JP)

(72) Inventor: Yuzo SHIMONO, Tokyo (JP)

(21) Appl. No.: 19/295,803

(22) Filed: Aug. 11, 2025

(30) Foreign Application Priority Data
Aug. 23, 2024 (JP) 2024-142441

(51) Int. Cl. G05D 1/69; G05D 1/246; G05D 101/15; G05D 105/55; G05D 105/80; G05D 109/20; G05D 111/10; G06V 10/82; G06V 20/17; G06V 40/16

(52) U.S. Cl. CPC G05D 1/69; G05D 1/2465; G06V 10/82; G06V 20/17; G06V 40/174; G05D 2101/15; G05D 2105/55; G05D 2105/80; G05D 2109/20; G05D 2111/10

(57) ABSTRACT

The system according to the embodiment comprises an activation unit, a data collection unit, an analysis unit, and a visualization unit. The activation unit activates a drone. The data collection unit processes data collected by the drone activated by the activation unit. The analysis unit analyzes the data collected by the data collection unit. The visualization unit visualizes the data analyzed by the analysis unit.

### CROSS-REFERENCE TO RELATED APPLICATION

The present application claims priority to and incorporates by reference the entire contents of Japanese Patent Application No. 2024-142441 filed in Japan on Aug. 23, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in that it is difficult to quickly and accurately grasp the damage situation when a disaster occurs.

### SUMMARY OF THE INVENTION

The system according to the embodiment comprises an activation unit, a data collection unit, an analysis unit, and a visualization unit. The activation unit activates a drone. The data collection unit processes data collected by the drone activated by the activation unit. The analysis unit analyzes the data collected by the data collection unit. The visualization unit visualizes the data analyzed by the analysis unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

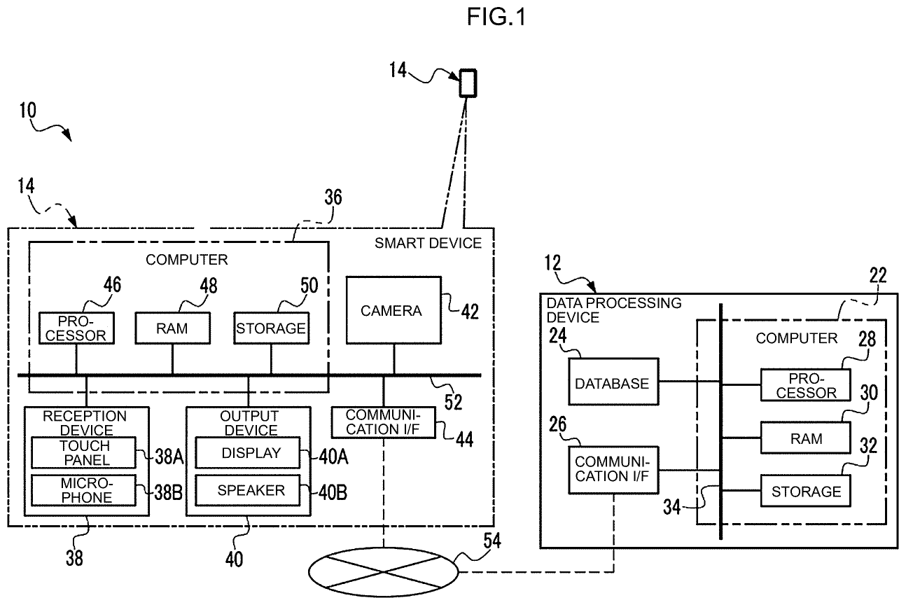

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

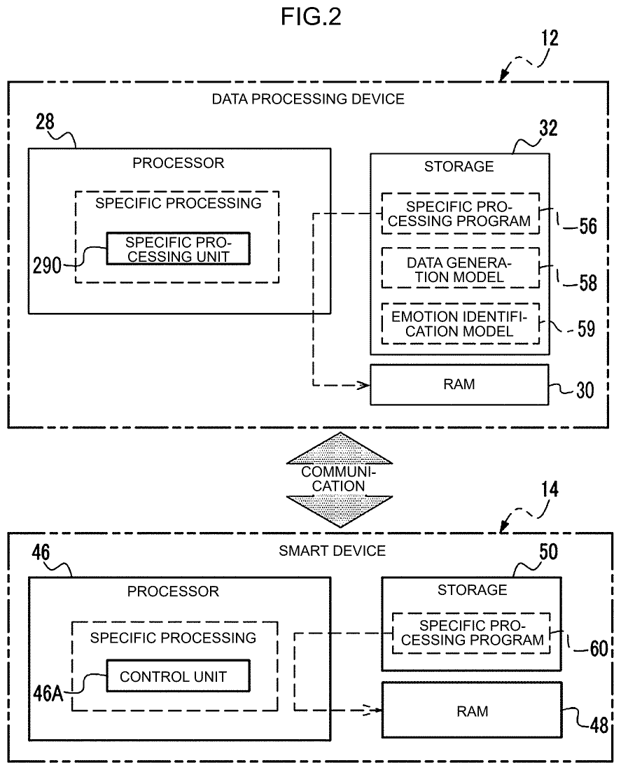

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The disaster damage assessment system according to the embodiment of the present invention is a system for quickly confirming the damage situation when a disaster occurs. This system simultaneously activates multiple drones within one hour after the occurrence of a disaster and maps the damage situation using drones equipped with cameras. Next, the vast amount of damage situation data collected by the drones is analyzed by generative AI and visualized as a 3D map. The generative AI processes these data at overwhelming speed, enabling real-time understanding of the damage situation at the site. For example, when a disaster occurs, the system automatically activates multiple drones. These drones are equipped with cameras and capture images of the damage situation. For example, they capture detailed images of building collapses and road damage. Next, the damage situation data collected by the drones is sent to the generative AI. The generative AI analyzes these data and visualizes them as a 3D map. For example, the building collapse situation is displayed on the 3D map, allowing one to instantly grasp which buildings have suffered what degree of damage. Furthermore, the generative AI processes these data at overwhelming speed. As a result, it is possible to grasp the damage situation at the site in real time. For example, within one hour after the disaster occurs, the damage situation can be grasped in detail, enabling a prompt response. Thus, the disaster damage assessment system can quickly grasp the damage situation at the time of a disaster, thereby improving the efficiency of rescue and recovery operations. For example, by prioritizing rescue in areas with severe damage, the damage can be minimized. In addition, recovery plans can be formulated quickly, enabling early recovery.

The disaster damage assessment system according to the embodiment comprises an activation unit, a data collection unit, an analysis unit, and a visualization unit. The activation unit activates a drone. For example, the activation unit simultaneously activates multiple drones within one hour after the occurrence of a disaster. The activation unit can also activate drones by methods such as manual activation, remote activation, or timer activation. The data collection unit processes data collected by the drone activated by the activation unit. For example, the data collection unit captures images of the damage situation using a drone equipped with a camera. Specific specifications and performance of the camera include resolution, field of view, and zoom function. The analysis unit analyzes the data collected by the data collection unit. For example, the analysis unit analyzes the damage situation data using generative AI. The generative AI analyzes the data using specific algorithms and training datasets. The visualization unit visualizes the data analyzed by the analysis unit. For example, the visualization unit visualizes the damage situation as a 3D map using generative AI. The 3D map generation method and display format include the software and data formats used. Thus, the disaster damage assessment system according to the embodiment can quickly confirm the damage situation when a disaster occurs and grasp the damage situation at the site in real time.

The activation unit can simultaneously activate multiple drones within one hour after the occurrence of a disaster. Specific methods and criteria for measuring the time within one hour after the disaster include the definition of disaster occurrence and the starting point for time measurement. For example, after receiving a disaster occurrence signal, the activation unit starts a timer and activates multiple drones simultaneously within one hour. The activation unit can also automatically select the number and types of drones to be activated according to the type and scale of the disaster. This enables rapid activation of drones after a disaster and confirmation of the damage situation.

The data collection unit can capture images of the damage situation using a drone equipped with a camera. Specific specifications and performance of the drone equipped with a camera include resolution, field of view, and zoom function. For example, the data collection unit uses a high-resolution camera to capture detailed images of building collapse situations. The data collection unit can also use a wide-angle camera to confirm a wide range of damage situations. Furthermore, the data collection unit can use a zoom function to check specific damage locations in detail. This enables the drone's camera to capture detailed images of the damage situation.

The analysis unit can analyze the damage situation data using generative AI. Specific types and implementation methods of generative AI include specific algorithms and training datasets. For example, the analysis unit analyzes the damage situation data using image analysis algorithms. The analysis unit can also analyze the damage situation data using data mining techniques. Furthermore, the analysis unit can analyze the damage situation data using machine learning algorithms. This improves the accuracy of damage situation data analysis by using generative AI.

The visualization unit can visualize the damage situation as a 3D map using generative AI. Specific methods for generating and displaying 3D maps include the software and data formats used. For example, the visualization unit displays the building collapse situation on a 3D map using generative AI. The visualization unit can also display road damage situations on a 3D map using generative AI.

Furthermore, the visualization unit can display information related to human life on a 3D map using generative AI. This enables visualization of the damage situation as a 3D map using generative AI.

The analysis unit can rapidly process the damage situation data. Specific criteria and methods for rapid processing include target processing times and the performance of the hardware used. For example, the analysis unit rapidly processes the damage situation data using a high-performance processor. The analysis unit can also rapidly process the damage situation data using parallel processing technology. Furthermore, the analysis unit can rapidly process the damage situation data using cloud computing technology. This enables rapid processing of damage situation data and real-time understanding of the situation at the site.

The visualization unit can grasp the damage situation at the site in real time. Specific definitions and criteria for real time include the frequency of data updates and the allowable range of delay time. For example, the visualization unit grasps the damage situation in real time by increasing the frequency of data updates. The visualization unit can also grasp the damage situation in real time by minimizing delay time. Furthermore, the visualization unit can process data in real time and immediately display the damage situation at the site. This enables real-time understanding of the damage situation at the site.

The activation unit can automatically select the number and types of drones to be activated according to the type and scale of the disaster. Specific classification criteria and evaluation methods for the type and scale of disasters include classifications such as earthquakes, floods, and fires, and evaluation criteria for the degree of damage. For example, in the case of an earthquake, the activation unit prioritizes the activation of drones equipped with high-resolution cameras to check building collapse situations. In the case of a flood, the activation unit can additionally activate underwater drones to measure water levels. Furthermore, in the case of a fire, the activation unit can activate drones equipped with heat sensors to check the spread of the fire. This enables optimal selection of drones according to the type and scale of the disaster.

The activation unit can set an optimal activation schedule by considering the remaining battery level and flight time of the drones. Specific measurement methods and criteria for battery level and flight time include the percentage of remaining battery and available flight time. For example, the activation unit uses drones with low battery levels for short-range damage assessment. The activation unit can also use drones with long flight times for wide-area damage assessment. Furthermore, the activation unit can set a schedule so that drones with easily replaceable batteries can be used continuously. This enables efficient operation by considering the remaining battery level and flight time of the drones.

The activation unit can monitor environmental conditions such as weather and wind speed in real time when activating drones and set optimal flight routes. Specific measurement methods and criteria for environmental conditions such as weather and wind speed include the sensors used and the frequency of data updates. For example, the activation unit sets a stable flight route by considering wind speed during strong winds. The activation unit can also prioritize the activation of waterproof drones during rainy weather. Furthermore, when the temperature is low, the activation unit can set a short flight route to reduce battery consumption. This enables the setting of optimal flight routes by considering environmental conditions.

The activation unit can select priority flight areas by considering geographic damage prediction data when activating drones. Specific acquisition methods and criteria for geographic damage prediction data include the data sources and prediction algorithms used. For example, the activation unit prioritizes flights in areas predicted to have severe damage. The activation unit can also prioritize flights in areas with important infrastructure (such as hospitals and fire stations). Furthermore, the activation unit can prioritize flights in areas with high population density. This enables the selection of priority flight areas by considering geographic damage prediction data.

The activation unit can set the optimal activation timing by considering cooperation with other disaster response systems when activating drones. Specific methods and criteria for cooperation with other disaster response systems include data sharing protocols and the types of systems to be linked. For example, the activation unit adjusts the drone activation timing in cooperation with fire and police activities. The activation unit can also adjust the drone activation timing in cooperation with emergency medical teams. Furthermore, the activation unit can adjust the drone activation timing in cooperation with the disaster response headquarters of local governments.

This enables the setting of optimal activation timing by considering cooperation with other disaster response systems.

The activation unit can learn and apply optimal flight patterns by referring to past disaster data when activating drones. Specific acquisition methods and criteria for past disaster data include data sources and types of data. For example, the activation unit prioritizes flights in areas where building collapse is predicted based on past earthquake data. The activation unit can also prioritize flights in areas where water levels are likely to rise based on past flood data. Furthermore, the activation unit can prioritize flights in areas where fires are likely to spread based on past fire data. This enables learning and application of optimal flight patterns by referring to past disaster data.

The data collection unit can automatically adjust the resolution and shooting angle of the drone's camera according to the damage situation. Specific adjustment methods and criteria for camera resolution and shooting angle include numerical values for resolution and ranges for shooting angles. For example, the data collection unit captures images at high resolution to check building collapse situations in detail. The data collection unit can also capture images at a wide angle to check a wide range of damage situations. Furthermore, the data collection unit can use the zoom function to check specific damage locations in detail. This enables automatic adjustment of camera resolution and shooting angle according to the damage situation.

The data collection unit can filter the data collected by the drone's camera in real time and extract only important information. Specific methods and criteria for filtering include filtering algorithms and definitions of important information. For example, the data collection unit prioritizes the extraction of building collapse situations. The data collection unit can also prioritize the extraction of road damage situations. Furthermore, the data collection unit can prioritize the extraction of information related to human life. This enables real-time extraction of only important information.

The data collection unit can integrate the data collected by the drone's camera with other sensors (such as temperature, humidity, and gas concentration) for multifaceted analysis. Specific types and usage methods of other sensors include temperature sensors, humidity sensors, and gas concentration sensors. For example, the data collection unit integrates with temperature sensor data to check the spread of fire. The data collection unit can also integrate with humidity sensor data to check the impact of flooding. Furthermore, the data collection unit can integrate with gas concentration sensor data to check the occurrence of hazardous gases. This enables multifaceted analysis by integrating with other sensors.

The data collection unit can display the data collected by the drone's camera on a map in real time by linking with a geographic information system (GIS).

Specific types and usage methods of geographic information systems (GIS) include the software and data formats used.

For example, the data collection unit displays the damage situation on a map in real time to check the extent of the damage. The data collection unit can also display the damage situation on a map in real time to check the severity of the damage. Furthermore, the data collection unit can display the damage situation on a map in real time to determine the priority of rescue activities. This enables real-time display of the damage situation on a map.

The data collection unit can automatically upload the data collected by the drone's camera to cloud storage and share it with other disaster response teams. Specific types and usage methods of cloud storage include the cloud services used and data upload methods. For example, the data collection unit uploads damage situation data to cloud storage and shares it with other disaster response teams. The data collection unit can also upload damage situation data to cloud storage and share it in real time. Furthermore, the data collection unit can upload damage situation data to cloud storage and share it quickly. This enables uploading data to cloud storage and sharing it with other disaster response teams.

The data collection unit can perform initial analysis of the data collected by the drone's camera using AI and quickly extract important information. Specific methods and criteria for initial analysis by AI include the algorithms used and the target data for analysis. For example, the data collection unit enables AI to quickly extract building collapse situations. The data collection unit can also enable AI to quickly extract road damage situations. Furthermore, the data collection unit can enable AI to quickly extract information related to human life. This enables quick extraction of important information through initial analysis by AI.

The analysis unit can evaluate the reliability of the damage situation data during analysis and exclude data with low reliability. Specific evaluation criteria and methods for reliability include the source of the data and the consistency of the data. For example, the analysis unit excludes data if the data source is unclear. The analysis unit can also exclude data if the data collection time is unclear. Furthermore, the analysis unit can exclude data if the data collection method is unclear. This improves the accuracy of analysis results by excluding data with low reliability.

The analysis unit can analyze the damage situation data in chronological order during analysis and predict the progress of the damage. Specific methods and criteria for time series analysis include time intervals and algorithms used. For example, the analysis unit analyzes the damage situation data in chronological order and predicts the progress of the damage. The analysis unit can also analyze the damage situation data in chronological order and predict the expansion of the damage. Furthermore, the analysis unit can analyze the damage situation data in chronological order and predict the convergence of the damage. This enables prediction of the progress of the damage by analyzing the damage situation data in chronological order.

The analysis unit can comprehensively analyze the damage situation data by integrating it with other disaster data (such as seismic wave and weather data) during analysis. Specific types and acquisition methods of other disaster data include seismic wave data and weather data. For example, the analysis unit integrates with seismic wave data to comprehensively analyze building collapse situations. The analysis unit can also integrate with weather data to comprehensively analyze the impact of flooding. Furthermore, the analysis unit can integrate with other disaster data to comprehensively analyze the overall damage situation. This enables comprehensive analysis by integrating with other disaster data.

The analysis unit can cluster the damage situation data during analysis and classify it according to the type and degree of damage. Specific methods and criteria for clustering include the algorithms used and the number of clusters. For example, the analysis unit clusters building collapse situations and classifies them according to the degree of damage. The analysis unit can also cluster road damage situations and classify them according to the degree of damage. Furthermore, the analysis unit can cluster information related to human life and classify it according to the degree of damage. This enables clustering of damage situation data and classification according to the type and degree of damage.

The analysis unit can perform comprehensive damage assessment by linking the damage situation data with other disaster response systems during analysis. Specific methods and criteria for linking with other disaster response systems include data sharing protocols and the types of systems to be linked. For example, the analysis unit performs comprehensive damage assessment by linking with fire and police data. The analysis unit can also perform comprehensive damage assessment by linking with emergency medical team data. Furthermore, the analysis unit can perform comprehensive damage assessment by linking with the disaster response headquarters data of local governments. This enables comprehensive damage assessment by linking with other disaster response systems.

The analysis unit can compare the damage situation data with past disaster data during analysis and identify similar damage patterns. Specific acquisition methods and criteria for past disaster data include data sources and types of data. For example, the analysis unit compares with past earthquake data and identifies similar damage patterns. The analysis unit can also compare with past flood data and identify similar damage patterns. Furthermore, the analysis unit can compare with past fire data and identify similar damage patterns. This enables identification of similar damage patterns by comparing with past disaster data.

The visualization unit can display the damage situation data on a 3D map during visualization and indicate the degree of damage using color coding. Specific methods for generating and displaying 3D maps include the software and data formats used. For example, the visualization unit displays building collapse situations on a 3D map and indicates the degree of damage using color coding. The visualization unit can also display road damage situations on a 3D map and indicate the degree of damage using color coding. Furthermore, the visualization unit can display information related to human life on a 3D map and indicate the degree of damage using color coding. This enables color-coded display of damage situation data on a 3D map.

The visualization unit can make the damage situation data interactively operable during visualization and display detailed information. Specific methods and criteria for interactive operation include the interfaces used and the range of operable actions. For example, the visualization unit displays detailed damage information for a specific building when the building is clicked on the 3D map. The visualization unit can also display detailed road damage information when a specific road is clicked on the 3D map. Furthermore, the visualization unit can display detailed damage information for a specific area when the area is clicked on the 3D map. This enables interactive operation of damage situation data and display of detailed information.

The visualization unit can display the damage situation data overlaid with other map data (such as roads and buildings) during visualization. Specific types and acquisition methods of other map data include road data and building data. For example, the visualization unit overlays the damage situation data with road maps to check road damage situations. The visualization unit can also overlay the damage situation data with building maps to check building collapse situations. Furthermore, the visualization unit can overlay the damage situation data with topographic maps to check changes in terrain. This enables overlay display of damage situation data with other map data.

The visualization unit can display the damage situation data along a time axis during visualization and show the progress of the damage as an animation. Specific methods and criteria for time axis display include time intervals and display formats. For example, the visualization unit displays the damage situation data along a time axis and shows the progress of the damage as an animation. The visualization unit can also display the damage situation data along a time axis and show the expansion of the damage as an animation. Furthermore, the visualization unit can display the damage situation data along a time axis and show the convergence of the damage as an animation. This enables display of the damage situation data along a time axis and animation of the progress of the damage.

The visualization unit can share the damage situation data with other disaster response teams during visualization and jointly consider countermeasures. Specific methods and criteria for sharing with other disaster response teams include data sharing protocols and platforms used. For example, the visualization unit shares the damage situation data with other disaster response teams and jointly considers countermeasures. The visualization unit can also share the damage situation data with other disaster response teams and quickly consider countermeasures. Furthermore, the visualization unit can share the damage situation data with other disaster response teams and consider effective countermeasures. This enables sharing of damage situation data with other disaster response teams and joint consideration of countermeasures.

The visualization unit can enable the display of damage situation data on mobile devices such as smartphones and tablets during visualization. Specific types and usage methods of mobile devices include smartphones and tablets. For example, the visualization unit displays damage situation data on a smartphone to facilitate on-site confirmation. The visualization unit can also display damage situation data on a tablet to check detailed information. Furthermore, the visualization unit can display damage situation data on mobile devices to enable prompt response. This enables the display of damage situation data on mobile devices and facilitates on-site confirmation.

The system according to the embodiment is not limited to the above-described examples and, for example, various modifications are possible as described below.

The activation unit can check the status of surrounding communication infrastructure when a disaster occurs and prioritize the activation of drones in areas where communication is available. For example, in areas where communication infrastructure is damaged, drones are launched from areas where communication is available to check the damage situation. When communication infrastructure is restored, drone activation in that area can be resumed immediately. Furthermore, the activation unit can optimize drone flight routes according to the status of the communication infrastructure to efficiently check the damage situation. This enables optimization of drone activation and flight routes by considering the status of the communication infrastructure.

The data collection unit can automatically extract the difference in damage by comparing the data collected by the drone with pre-disaster data. For example, by comparing the state of buildings before the disaster, collapsed parts can be identified. By comparing the state of roads before the disaster, damaged parts can also be identified. Furthermore, by comparing pre-disaster terrain data, changes in terrain can also be identified. This enables automatic extraction of damage differences by comparing pre-and post-disaster data.

The analysis unit can assign priorities for analysis according to the severity of the damage when analyzing the damage situation data. For example, areas with severe building collapse are analyzed with priority. Areas with severe road damage can also be analyzed with priority. Furthermore, areas containing information related to human life can also be analyzed with priority. This enables prioritization of analysis according to the severity of the damage and prompt response.

The visualization unit can prioritize the display of the nearest damage situation by considering the user's location information when visualizing the damage situation data. For example, if the user is at the site, the damage situation in the surrounding area is displayed with priority. If the user is in a remote location, the overall damage situation can be displayed from a bird's-eye view. Furthermore, the displayed damage situation can be updated in real time according to the user's movement. This enables prioritization of the display of the nearest damage situation by considering the user's location information.

The analysis unit can import data from other disaster response systems in real time when analyzing the damage situation data and perform a comprehensive damage assessment. For example, data from fire and police departments can be imported to comprehensively assess building collapse situations. Data from emergency medical teams can also be imported to comprehensively assess the status of the injured. Furthermore, data from the disaster response headquarters of local governments can be imported to comprehensively assess the overall damage situation. This enables real-time import of data from other disaster response systems and comprehensive damage assessment.

The following is a brief description of the processing flow of Example 1 of the Embodiment.
Step 1: The activation unit activates the drone. For example, the activation unit simultaneously activates multiple drones within one hour after the occurrence of a disaster. The activation unit can also activate drones by methods such as manual activation, remote activation, or timer activation.
Step 2: The data collection unit processes the data collected by the drone activated by the activation unit. For example, the data collection unit captures images of the damage situation using a drone equipped with a camera. Specific specifications and performance of the camera include resolution, field of view, and zoom function.
Step 3: The analysis unit analyzes the data collected by the data collection unit. For example, the analysis unit analyzes the damage situation data using generative AI. The generative AI analyzes the data using specific algorithms and training datasets.
Step 4: The visualization unit visualizes the data analyzed by the analysis unit. For example, the visualization unit visualizes the damage situation as a 3D map using generative AI. The 3D map generation method and display format include the software and data formats used.

### Example 2 of Embodiment

The disaster damage assessment system according to the embodiment of the present invention is a system for quickly confirming the damage situation when a disaster occurs. This system simultaneously activates multiple drones within one hour after the occurrence of a disaster and maps the damage situation using drones equipped with cameras. Next, the vast amount of damage situation data collected by the drones is analyzed by generative AI and visualized as a 3D map. The generative AI processes these data at overwhelming speed, enabling real-time understanding of the damage situation at the site. For example, when a disaster occurs, the system automatically activates multiple drones. These drones are equipped with cameras and capture images of the damage situation. For example, they capture detailed images of building collapses and road damage. Next, the damage situation data collected by the drones is sent to the generative AI. The generative AI analyzes these data and visualizes them as a 3D map. For example, the building collapse situation is displayed on the 3D map, allowing one to instantly grasp which buildings have suffered what degree of damage. Furthermore, the generative AI processes these data at overwhelming speed. As a result, it is possible to grasp the damage situation at the site in real time. For example, within one hour after the disaster occurs, the damage situation can be grasped in detail, enabling a prompt response. Thus, the disaster damage assessment system can quickly grasp the damage situation at the time of a disaster, thereby improving the efficiency of rescue and recovery operations. For example, by prioritizing rescue in areas with severe damage, the damage can be minimized. In addition, recovery plans can be formulated quickly, enabling early recovery.

The disaster damage assessment system according to the embodiment comprises an activation unit, a data collection unit, an analysis unit, and a visualization unit. The activation unit activates a drone. For example, the activation unit simultaneously activates multiple drones within one hour after the occurrence of a disaster. The activation unit can also activate drones by methods such as manual activation, remote activation, or timer activation. The data collection unit processes data collected by the drone activated by the activation unit. For example, the data collection unit captures images of the damage situation using a drone equipped with a camera. Specific specifications and performance of the camera include resolution, field of view, and zoom function. The analysis unit analyzes the data collected by the data collection unit. For example, the analysis unit analyzes the damage situation data using generative AI. The generative AI analyzes the data using specific algorithms and training datasets. The visualization unit visualizes the data analyzed by the analysis unit. For example, the visualization unit visualizes the damage situation as a 3D map using generative AI. The 3D map generation method and display format include the software and data formats used. Thus, the disaster damage assessment system according to the embodiment can quickly confirm the damage situation when a disaster occurs and grasp the damage situation at the site in real time.

The activation unit can simultaneously activate multiple drones within one hour after the occurrence of a disaster. Specific methods and criteria for measuring the time within one hour after the disaster include the definition of disaster occurrence and the starting point for time measurement. For example, after receiving a disaster occurrence signal, the activation unit starts a timer and activates multiple drones simultaneously within one hour. The activation unit can also automatically select the number and types of drones to be activated according to the type and scale of the disaster. This enables rapid activation of drones after a disaster and confirmation of the damage situation.

The data collection unit can capture images of the damage situation using a drone equipped with a camera. Specific specifications and performance of the drone equipped with a camera include resolution, field of view, and zoom function. For example, the data collection unit uses a high-resolution camera to capture detailed images of building collapse situations. The data collection unit can also use a wide-angle camera to confirm a wide range of damage situations. Furthermore, the data collection unit can use a zoom function to check specific damage locations in detail. This enables the drone's camera to capture detailed images of the damage situation.

The analysis unit can analyze the damage situation data using generative AI. Specific types and implementation methods of generative AI include specific algorithms and training datasets. For example, the analysis unit analyzes the damage situation data using image analysis algorithms. The analysis unit can also analyze the damage situation data using data mining techniques. Furthermore, the analysis unit can analyze the damage situation data using machine learning algorithms. This improves the accuracy of damage situation data analysis by using generative AI.

The visualization unit can visualize the damage situation as a 3D map using generative AI. Specific methods for generating and displaying 3D maps include the software and data formats used. For example, the visualization unit displays the building collapse situation on a 3D map using generative AI. The visualization unit can also display road damage situations on a 3D map using generative AI. Furthermore, the visualization unit can display information related to human life on a 3D map using generative AI. This enables visualization of the damage situation as a 3D map using generative AI.

The analysis unit can rapidly process the damage situation data. Specific criteria and methods for rapid processing include target processing times and the performance of the hardware used. For example, the analysis unit rapidly processes the damage situation data using a high-performance processor. The analysis unit can also rapidly process the damage situation data using parallel processing technology. Furthermore, the analysis unit can rapidly process the damage situation data using cloud computing technology. This enables rapid processing of damage situation data and real-time understanding of the situation at the site.

The visualization unit can grasp the damage situation at the site in real time. Specific definitions and criteria for real time include the frequency of data updates and the allowable range of delay time. For example, the visualization unit grasps the damage situation in real time by increasing the frequency of data updates. The visualization unit can also grasp the damage situation in real time by minimizing delay time. Furthermore, the visualization unit can process data in real time and immediately display the damage situation at the site. This enables real-time understanding of the damage situation at the site.

The activation unit can estimate the user's emotion and determine the activation timing of the drone based on the estimated user emotion. Specific estimation methods and criteria for the user's emotion include emotion recognition algorithms and sensors used. For example, the activation unit captures the user's facial expression with a camera and estimates the emotion using an emotion recognition algorithm. The activation unit can also record the user's voice and estimate the emotion using voice analysis technology. Furthermore, the activation unit can collect the user's biometric data (such as heart rate and skin conductance) with sensors and estimate the emotion using an emotion recognition algorithm. This enables adjustment of the drone activation timing according to the user's emotion. For example, if the user is nervous, the drone activation timing is advanced to quickly check the damage situation. If the user is calm, the drone is activated at the optimal timing to efficiently check the damage situation. If the user is in a panic state, drone activation is automated to minimize user operation.

The activation unit can automatically select the number and types of drones to be activated according to the type and scale of the disaster. Specific classification criteria and evaluation methods for the type and scale of disasters include classifications such as earthquakes, floods, and fires, and evaluation criteria for the degree of damage. For example, in the case of an earthquake, the activation unit prioritizes the activation of drones equipped with high-resolution cameras to check building collapse situations. In the case of a flood, the activation unit can additionally activate underwater drones to measure water levels. Furthermore, in the case of a fire, the activation unit can activate drones equipped with heat sensors to check the spread of the fire. This enables optimal selection of drones according to the type and scale of the disaster.

The activation unit can set an optimal activation schedule by considering the remaining battery level and flight time of the drones. Specific measurement methods and criteria for battery level and flight time include the percentage of remaining battery and available flight time. For example, the activation unit uses drones with low battery levels for short-range damage assessment. The activation unit can also use drones with long flight times for wide-area damage assessment. Furthermore, the activation unit can set a schedule so that drones with easily replaceable batteries can be used continuously. This enables efficient operation by considering the remaining battery level and flight time of the drones.

The activation unit can monitor environmental conditions such as weather and wind speed in real time when activating drones and set optimal flight routes. Specific measurement methods and criteria for environmental conditions such as weather and wind speed include the sensors used and the frequency of data updates. For example, the activation unit sets a stable flight route by considering wind speed during strong winds. The activation unit can also prioritize the activation of waterproof drones during rainy weather. Furthermore, when the temperature is low, the activation unit can set a short flight route to reduce battery consumption. This enables the setting of optimal flight routes by considering environmental conditions.

The activation unit can estimate the user's emotion and determine the priority of drones to be activated based on the estimated user emotion. Specific estimation methods and criteria for the user's emotion include emotion recognition algorithms and sensors used. For example, the activation unit captures the user's facial expression with a camera and estimates the emotion using an emotion recognition algorithm. The activation unit can also record the user's voice and estimate the emotion using voice analysis technology. Furthermore, the activation unit can collect the user's biometric data (such as heart rate and skin conductance) with sensors and estimate the emotion using an emotion recognition algorithm. This enables determination of the priority of drones to be activated according to the user's emotion. For example, if the user is nervous, the most reliable drone is activated with priority. If the user is calm, multiple drones are efficiently activated simultaneously. If the user is in a panic state, all drones are activated at once to quickly check the damage situation.

The activation unit can select priority flight areas by considering geographic damage prediction data when activating drones. Specific acquisition methods and criteria for geographic damage prediction data include the data sources and prediction algorithms used. For example, the activation unit prioritizes flights in areas predicted to have severe damage. The activation unit can also prioritize flights in areas with important infrastructure (such as hospitals and fire stations). Furthermore, the activation unit can prioritize flights in areas with high population density. This enables the selection of priority flight areas by considering geographic damage prediction data.

The activation unit can set the optimal activation timing by considering cooperation with other disaster response systems when activating drones. Specific methods and criteria for cooperation with other disaster response systems include data sharing protocols and the types of systems to be linked. For example, the activation unit adjusts the drone activation timing in cooperation with fire and police activities. The activation unit can also adjust the drone activation timing in cooperation with emergency medical teams. Furthermore, the activation unit can adjust the drone activation timing in cooperation with the disaster response headquarters of local governments.

This enables the setting of optimal activation timing by considering cooperation with other disaster response systems.

The activation unit can learn and apply optimal flight patterns by referring to past disaster data when activating drones. Specific acquisition methods and criteria for past disaster data include data sources and types of data. For example, the activation unit prioritizes flights in areas where building collapse is predicted based on past earthquake data. The activation unit can also prioritize flights in areas where water levels are likely to rise based on past flood data. Furthermore, the activation unit can prioritize flights in areas where fires are likely to spread based on past fire data. This enables learning and application of optimal flight patterns by referring to past disaster data.

The data collection unit can estimate the user's emotion and determine the priority of damage situations to be captured based on the estimated user emotion. Specific estimation methods and criteria for the user's emotion include emotion recognition algorithms and sensors used.

For example, the data collection unit captures the user's facial expression with a camera and estimates the emotion using an emotion recognition algorithm. The data collection unit can also record the user's voice and estimate the emotion using voice analysis technology. Furthermore, the data collection unit can collect the user's biometric data (such as heart rate and skin conductance) with sensors and estimate the emotion using an emotion recognition algorithm. This enables determination of the priority of damage situations to be captured according to the user's emotion. For example, if the user is nervous, the most important damage situation is captured with priority. If the user is calm, multiple damage situations are efficiently captured simultaneously. If the user is in a panic state, all damage situations are captured at once.

The data collection unit can automatically adjust the resolution and shooting angle of the drone's camera according to the damage situation. Specific adjustment methods and criteria for camera resolution and shooting angle include numerical values for resolution and ranges for shooting angles. For example, the data collection unit captures images at high resolution to check building collapse situations in detail. The data collection unit can also capture images at a wide angle to check a wide range of damage situations. Furthermore, the data collection unit can use the zoom function to check specific damage locations in detail. This enables automatic adjustment of camera resolution and shooting angle according to the damage situation.

The data collection unit can filter the data collected by the drone's camera in real time and extract only important information. Specific methods and criteria for filtering include filtering algorithms and definitions of important information. For example, the data collection unit prioritizes the extraction of building collapse situations. The data collection unit can also prioritize the extraction of road damage situations. Furthermore, the data collection unit can prioritize the extraction of information related to human life. This enables real-time extraction of only important information.

The data collection unit can integrate the data collected by the drone's camera with other sensors (such as temperature, humidity, and gas concentration) for multifaceted analysis. Specific types and usage methods of other sensors include temperature sensors, humidity sensors, and gas concentration sensors. For example, the data collection unit integrates with temperature sensor data to check the spread of fire. The data collection unit can also integrate with humidity sensor data to check the impact of flooding. Furthermore, the data collection unit can integrate with gas concentration sensor data to check the occurrence of hazardous gases. This enables multifaceted analysis by integrating with other sensors.

The data collection unit can estimate the user's emotion and adjust the level of detail of the damage situation to be captured based on the estimated user emotion. Specific estimation methods and criteria for the user's emotion include emotion recognition algorithms and sensors used. For example, the data collection unit captures the user's facial expression with a camera and estimates the emotion using an emotion recognition algorithm. The data collection unit can also record the user's voice and estimate the emotion using voice analysis technology. Furthermore, the data collection unit can collect the user's biometric data (such as heart rate and skin conductance) with sensors and estimate the emotion using an emotion recognition algorithm. This enables adjustment of the level of detail of the damage situation to be captured according to the user's emotion. For example, if the user is nervous, detailed damage situations are captured. If the user is calm, multiple damage situations are efficiently captured. If the user is in a panic state, all damage situations are captured in detail.

The data collection unit can display the data collected by the drone's camera on a map in real time by linking with a geographic information system (GIS). Specific types and usage methods of geographic information systems (GIS) include the software and data formats used. For example, the data collection unit displays the damage situation on a map in real time to check the extent of the damage. The data collection unit can also display the damage situation on a map in real time to check the severity of the damage. Furthermore, the data collection unit can display the damage situation on a map in real time to determine the priority of rescue activities. This enables real-time display of the damage situation on a map.

The data collection unit can automatically upload the data collected by the drone's camera to cloud storage and share it with other disaster response teams. Specific types and usage methods of cloud storage include the cloud services used and data upload methods. For example, the data collection unit uploads damage situation data to cloud storage and shares it with other disaster response teams.

The data collection unit can also upload damage situation data to cloud storage and share it in real time. Furthermore, the data collection unit can upload damage situation data to cloud storage and share it quickly. This enables uploading data to cloud storage and sharing it with other disaster response teams.

The data collection unit can perform initial analysis of the data collected by the drone's camera using AI and quickly extract important information. Specific methods and criteria for initial analysis by AI include the algorithms used and the target data for analysis. For example, the data collection unit enables AI to quickly extract building collapse situations. The data collection unit can also enable AI to quickly extract road damage situations.

Furthermore, the data collection unit can enable AI to quickly extract information related to human life. This enables quick extraction of important information through initial analysis by AI.

The analysis unit can estimate the user's emotion and adjust the display method of analysis results based on the estimated user emotion. Specific estimation methods and criteria for the user's emotion include emotion recognition algorithms and sensors used. For example, the analysis unit captures the user's facial expression with a camera and estimates the emotion using an emotion recognition algorithm. The analysis unit can also record the user's voice and estimate the emotion using voice analysis technology. Furthermore, the analysis unit can collect the user's biometric data (such as heart rate and skin conductance) with sensors and estimate the emotion using an emotion recognition algorithm. This enables adjustment of the display method of analysis results according to the user's emotion. For example, if the user is nervous, a simple and highly visible display method is provided. If the user is relaxed, a display method including detailed information is provided. If the user is in a hurry, a display method focusing on key points is provided.

The analysis unit can evaluate the reliability of the damage situation data during analysis and exclude data with low reliability. Specific evaluation criteria and methods for reliability include the source of the data and the consistency of the data. For example, the analysis unit excludes data if the data source is unclear. The analysis unit can also exclude data if the data collection time is unclear. Furthermore, the analysis unit can exclude data if the data collection method is unclear. This improves the accuracy of analysis results by excluding data with low reliability.

The analysis unit can analyze the damage situation data in chronological order during analysis and predict the progress of the damage. Specific methods and criteria for time series analysis include time intervals and algorithms used. For example, the analysis unit analyzes the damage situation data in chronological order and predicts the progress of the damage. The analysis unit can also analyze the damage situation data in chronological order and predict the expansion of the damage. Furthermore, the analysis unit can analyze the damage situation data in chronological order and predict the convergence of the damage. This enables prediction of the progress of the damage by analyzing the damage situation data in chronological order.

The analysis unit can comprehensively analyze the damage situation data by integrating it with other disaster data (such as seismic wave and weather data) during analysis. Specific types and acquisition methods of other disaster data include seismic wave data and weather data.

For example, the analysis unit integrates with seismic wave data to comprehensively analyze building collapse situations. The analysis unit can also integrate with weather data to comprehensively analyze the impact of flooding. Furthermore, the analysis unit can integrate with other disaster data to comprehensively analyze the overall damage situation. This enables comprehensive analysis by integrating with other disaster data.

The analysis unit can estimate the user's emotion and adjust the level of detail of analysis results based on the estimated user emotion. Specific estimation methods and criteria for the user's emotion include emotion recognition algorithms and sensors used. For example, the analysis unit captures the user's facial expression with a camera and estimates the emotion using an emotion recognition algorithm. The analysis unit can also record the user's voice and estimate the emotion using voice analysis technology. Furthermore, the analysis unit can collect the user's biometric data (such as heart rate and skin conductance) with sensors and estimate the emotion using an emotion recognition algorithm. This enables adjustment of the level of detail of analysis results according to the user's emotion. For example, if the user is nervous, detailed analysis results are provided. If the user is relaxed, analysis results are provided efficiently. If the user is in a hurry, analysis results focusing on key points are provided.

The analysis unit can cluster the damage situation data during analysis and classify it according to the type and degree of damage. Specific methods and criteria for clustering include the algorithms used and the number of clusters. For example, the analysis unit clusters building collapse situations and classifies them according to the degree of damage. The analysis unit can also cluster road damage situations and classify them according to the degree of damage. Furthermore, the analysis unit can cluster information related to human life and classify it according to the degree of damage. This enables clustering of damage situation data and classification according to the type and degree of damage.

The analysis unit can perform comprehensive damage assessment by linking the damage situation data with other disaster response systems during analysis. Specific methods and criteria for linking with other disaster response systems include data sharing protocols and the types of systems to be linked. For example, the analysis unit performs comprehensive damage assessment by linking with fire and police data. The analysis unit can also perform comprehensive damage assessment by linking with emergency medical team data. Furthermore, the analysis unit can perform comprehensive damage assessment by linking with the disaster response headquarters data of local governments. This enables comprehensive damage assessment by linking with other disaster response systems.

The analysis unit can compare the damage situation data with past disaster data during analysis and identify similar damage patterns. Specific acquisition methods and criteria for past disaster data include data sources and types of data. For example, the analysis unit compares with past earthquake data and identifies similar damage patterns. The analysis unit can also compare with past flood data and identify similar damage patterns. Furthermore, the analysis unit can compare with past fire data and identify similar damage patterns. This enables identification of similar damage patterns by comparing with past disaster data.

The visualization unit can estimate the user's emotion and adjust the display method of visualization based on the estimated user emotion. Specific estimation methods and criteria for the user's emotion include emotion recognition algorithms and sensors used. For example, the visualization unit captures the user's facial expression with a camera and estimates the emotion using an emotion recognition algorithm. The visualization unit can also record the user's voice and estimate the emotion using voice analysis technology. Furthermore, the visualization unit can collect the user's biometric data (such as heart rate and skin conductance) with sensors and estimate the emotion using an emotion recognition algorithm. This enables adjustment of the display method of visualization according to the user's emotion. For example, if the user is nervous, a simple and highly visible display method is provided. If the user is relaxed, a display method including detailed information is provided. If the user is in a hurry, a display method focusing on key points is provided.

The visualization unit can display the damage situation data on a 3D map during visualization and indicate the degree of damage using color coding. Specific methods for generating and displaying 3D maps include the software and data formats used. For example, the visualization unit displays building collapse situations on a 3D map and indicates the degree of damage using color coding. The visualization unit can also display road damage situations on a 3D map and indicate the degree of damage using color coding. Furthermore, the visualization unit can display information related to human life on a 3D map and indicate the degree of damage using color coding. This enables color-coded display of damage situation data on a 3D map.

The visualization unit can make the damage situation data interactively operable during visualization and display detailed information. Specific methods and criteria for interactive operation include the interfaces used and the range of operable actions. For example, the visualization unit displays detailed damage information for a specific building when the building is clicked on the 3D map. The visualization unit can also display detailed road damage information when a specific road is clicked on the 3D map. Furthermore, the visualization unit can display detailed damage information for a specific area when the area is clicked on the 3D map. This enables interactive operation of damage situation data and display of detailed information.

The visualization unit can display the damage situation data overlaid with other map data (such as roads and buildings) during visualization. Specific types and acquisition methods of other map data include road data and building data. For example, the visualization unit overlays the damage situation data with road maps to check road damage situations. The visualization unit can also overlay the damage situation data with building maps to check building collapse situations. Furthermore, the visualization unit can overlay the damage situation data with topographic maps to check changes in terrain. This enables overlay display of damage situation data with other map data.

The visualization unit can estimate the user's emotion and determine the priority of visualization based on the estimated user emotion. Specific estimation methods and criteria for the user's emotion include emotion recognition algorithms and sensors used. For example, the visualization unit captures the user's facial expression with a camera and estimates the emotion using an emotion recognition algorithm. The visualization unit can also record the user's voice and estimate the emotion using voice analysis technology. Furthermore, the visualization unit can collect the user's biometric data (such as heart rate and skin conductance) with sensors and estimate the emotion using an emotion recognition algorithm. This enables determination of the priority of visualization according to the user's emotion. For example, if the user is nervous, the most important damage situation is displayed with priority. If the user is calm, multiple damage situations are efficiently displayed simultaneously. If the user is in a panic state, all damage situations are displayed at once.

The visualization unit can display the damage situation data along a time axis during visualization and show the progress of the damage as an animation. Specific methods and criteria for time axis display include time intervals and display formats. For example, the visualization unit displays the damage situation data along a time axis and shows the progress of the damage as an animation. The visualization unit can also display the damage situation data along a time axis and show the expansion of the damage as an animation. Furthermore, the visualization unit can display the damage situation data along a time axis and show the convergence of the damage as an animation. This enables display of the damage situation data along a time axis and animation of the progress of the damage.

The visualization unit can share the damage situation data with other disaster response teams during visualization and jointly consider countermeasures. Specific methods and criteria for sharing with other disaster response teams include data sharing protocols and platforms used. For example, the visualization unit shares the damage situation data with other disaster response teams and jointly considers countermeasures. The visualization unit can also share the damage situation data with other disaster response teams and quickly consider countermeasures. Furthermore, the visualization unit can share the damage situation data with other disaster response teams and consider effective countermeasures. This enables sharing of damage situation data with other disaster response teams and joint consideration of countermeasures.

The visualization unit can enable the display of damage situation data on mobile devices such as smartphones and tablets during visualization. Specific types and usage methods of mobile devices include smartphones and tablets. For example, the visualization unit displays damage situation data on a smartphone to facilitate on-site confirmation. The visualization unit can also display damage situation data on a tablet to check detailed information. Furthermore, the visualization unit can display damage situation data on mobile devices to enable prompt response. This enables the display of damage situation data on mobile devices and facilitates on-site confirmation.

### Hardware Guarantee 1-1

Each of the above-described elements, including the activation unit, data collection unit, analysis unit, and visualization unit, is implemented, for example, by at least one of the smart device 14 and the data processing device 12. For example, the activation unit activates the drone by the control unit 46A of the smart device 14. The data collection unit captures the damage situation using the camera 42 of the smart device 14 and transmits it to the data processing device 12. The analysis unit analyzes the damage situation data using generative AI by the specific processing unit 290 of the data processing device 12. The visualization unit visualizes the data analyzed by the specific processing unit 290 of the data processing device 12 as a 3D map.

### Hardware Guarantee 1-2

Each of the above-described elements, including the activation unit, data collection unit, analysis unit, and visualization unit, is implemented, for example, by at least one of the smart glasses 214 and the data processing device 12. For example, the activation unit activates the drone by the control unit 46A of the smart glasses 214. The data collection unit captures the damage situation using the camera 42 of the smart glasses 214 and transmits it to the data processing device 12. The analysis unit analyzes the damage situation data using generative AI by the specific processing unit 290 of the data processing device 12. The visualization unit visualizes the data analyzed by the specific processing unit 290 of the data processing device 12 as a 3D map.

### Hardware Guarantee 1-3

Each of the above-described elements, including the activation unit, data collection unit, analysis unit, and visualization unit, is implemented, for example, by at least one of the headset-type terminal 314 and the data processing device 12. For example, the activation unit activates the drone by the control unit 46A of the headset-type terminal 314. The data collection unit captures the damage situation using the camera 42 of the headset-type terminal 314 and transmits it to the data processing device 12. The analysis unit analyzes the damage situation data using generative AI by the specific processing unit 290 of the data processing device 12. The visualization unit visualizes the data analyzed by the specific processing unit 290 of the data processing device 12 as a 3D map.

### Hardware Guarantee 1-4

Each of the above-described elements, including the activation unit, data collection unit, analysis unit, and visualization unit, is implemented, for example, by at least one of the robot 414 and the data processing device 12. For example, the activation unit activates the drone by the control unit 46A of the robot 414. The data collection unit captures the damage situation using the camera 42 of the robot 414 and transmits it to the data processing device 12. The analysis unit analyzes the damage situation data using generative AI by the specific processing unit 290 of the data processing device 12. The visualization unit visualizes the data analyzed by the specific processing unit 290 of the data processing device 12 as a 3D map.

The system according to the embodiment is not limited to the above-described examples and, for example, various modifications are possible as described below.

The activation unit can check the status of surrounding communication infrastructure when a disaster occurs and prioritize the activation of drones in areas where communication is available. For example, in areas where communication infrastructure is damaged, drones are launched from areas where communication is available to check the damage situation. When communication infrastructure is restored, drone activation in that area can be resumed immediately. Furthermore, the activation unit can optimize drone flight routes according to the status of the communication infrastructure to efficiently check the damage situation. This enables optimization of drone activation and flight routes by considering the status of the communication infrastructure.

The data collection unit can automatically extract the difference in damage by comparing the data collected by the drone with pre-disaster data. For example, by comparing the state of buildings before the disaster, collapsed parts can be identified. By comparing the state of roads before the disaster, damaged parts can also be identified.

Furthermore, by comparing pre-disaster terrain data, changes in terrain can also be identified. This enables automatic extraction of damage differences by comparing pre-and post-disaster data.

The analysis unit can assign priorities for analysis according to the severity of the damage when analyzing the damage situation data. For example, areas with severe building collapse are analyzed with priority. Areas with severe road damage can also be analyzed with priority.

Furthermore, areas containing information related to human life can also be analyzed with priority. This enables prioritization of analysis according to the severity of the damage and prompt response.

The visualization unit can prioritize the display of the nearest damage situation by considering the user's location information when visualizing the damage situation data. For example, if the user is at the site, the damage situation in the surrounding area is displayed with priority. If the user is in a remote location, the overall damage situation can be displayed from a bird's-eye view. Furthermore, the displayed damage situation can be updated in real time according to the user's movement. This enables prioritization of the display of the nearest damage situation by considering the user's location information.

The activation unit can estimate the user's emotion and adjust the flight altitude of the drone based on the estimated user emotion. For example, if the user is nervous, the drone flies at a low altitude to check the damage situation in detail. If the user is calm, the drone flies at a high altitude to check a wide area of the damage situation. If the user is in a panic state, the drone flies at the optimal altitude to quickly check the damage situation. This enables adjustment of the drone's flight altitude according to the user's emotion.

The data collection unit can estimate the user's emotion and adjust the flight speed of the drone based on the estimated user emotion. For example, if the user is nervous, the drone flies at a low speed to check the damage situation in detail. If the user is calm, the drone flies at a high speed to check a wide area of the damage situation. If the user is in a panic state, the drone flies at the optimal speed to quickly check the damage situation. This enables adjustment of the drone's flight speed according to the user's emotion.

The analysis unit can estimate the user's emotion and adjust the notification method of analysis results based on the estimated user emotion. For example, if the user is nervous, a simple and highly visible notification method is provided. If the user is relaxed, a notification method including detailed information is provided. If the user is in a hurry, a notification method focusing on key points is provided. This enables adjustment of the notification method of analysis results according to the user's emotion.

The visualization unit can estimate the user's emotion and adjust the color scheme of the visualization based on the estimated user emotion. For example, if the user is nervous, the display uses calm colors. If the user is relaxed, the display uses vivid colors. If the user is in a hurry, the display uses highly visible colors. This enables adjustment of the color scheme of the visualization according to the user's emotion.

The visualization unit can estimate the user's emotion and adjust the layout of the visualization based on the estimated user emotion. For example, if the user is nervous, a simple and highly visible layout is provided. If the user is relaxed, a layout including detailed information is provided. If the user is in a hurry, a layout focusing on key points is provided. This enables adjustment of the layout of the visualization according to the user's emotion.

The analysis unit can import data from other disaster response systems in real time when analyzing the damage situation data and perform a comprehensive damage assessment. For example, data from fire and police departments can be imported to comprehensively assess building collapse situations. Data from emergency medical teams can also be imported to comprehensively assess the status of the injured. Furthermore, data from the disaster response headquarters of local governments can be imported to comprehensively assess the overall damage situation.

This enables real-time import of data from other disaster response systems and comprehensive damage assessment.

The following is a brief description of the processing flow of Example 2 of the Embodiment.
Step 1: The activation unit activates the drone. For example, the activation unit simultaneously activates multiple drones within one hour after the occurrence of a disaster. The activation unit can also activate drones by methods such as manual activation, remote activation, or timer activation.
Step 2: The data collection unit processes the data collected by the drone activated by the activation unit. For example, the data collection unit captures images of the damage situation using a drone equipped with a camera. Specific specifications and performance of the camera include resolution, field of view, and zoom function.
Step 3: The analysis unit analyzes the data collected by the data collection unit. For example, the analysis unit analyzes the damage situation data using generative AI. The generative AI analyzes the data using specific algorithms and training datasets.
Step 4: The visualization unit visualizes the data analyzed by the analysis unit. For example, the visualization unit visualizes the damage situation as a 3D map using generative AI. The 3D map generation method and display format include the software and data formats used.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

The correspondence between each unit and the devices or control units is not limited to the above-described examples, and various modifications are possible.

### Second Embodiment

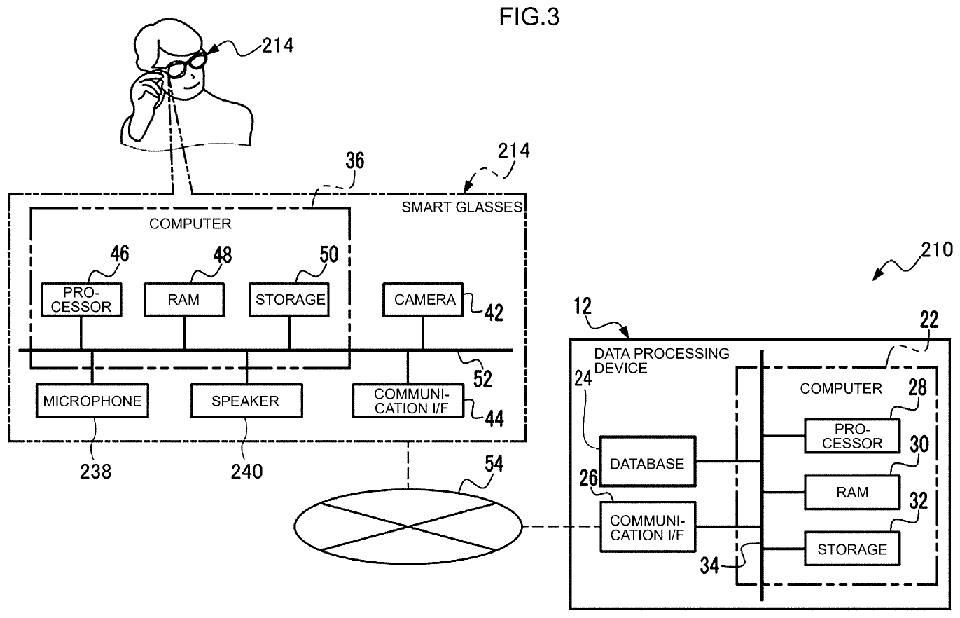

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

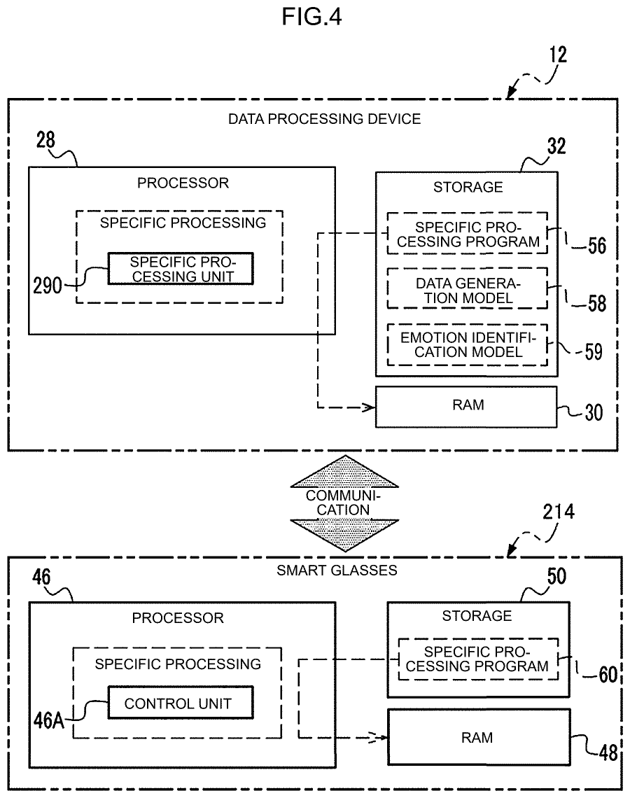

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

The correspondence between each unit and the devices or control units is not limited to the above-described examples, and various modifications are possible.

### Third Embodiment

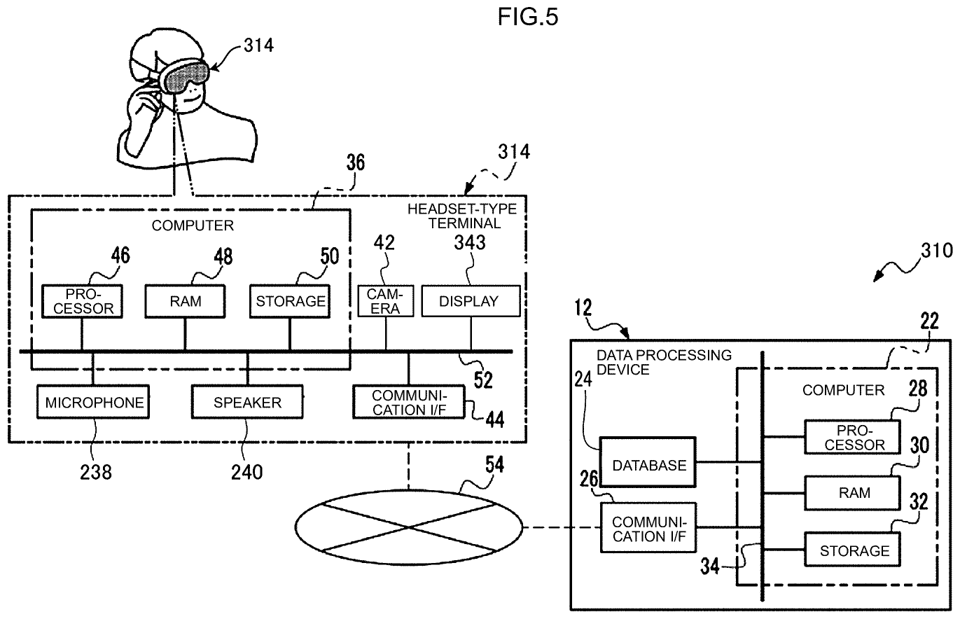

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

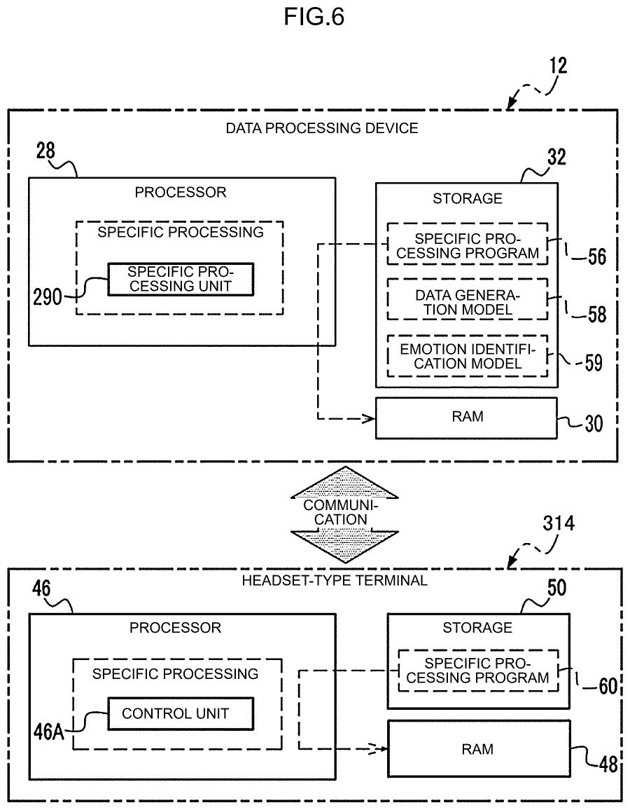

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314.

Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

The correspondence between each unit and the devices or control units is not limited to the above-described examples, and various modifications are possible.

### Fourth Embodiment

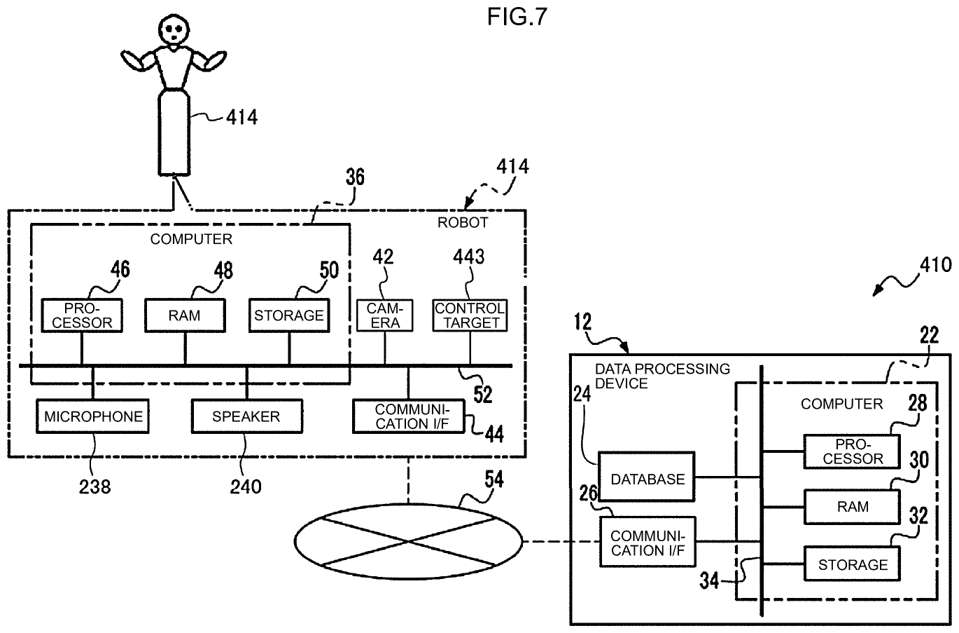

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

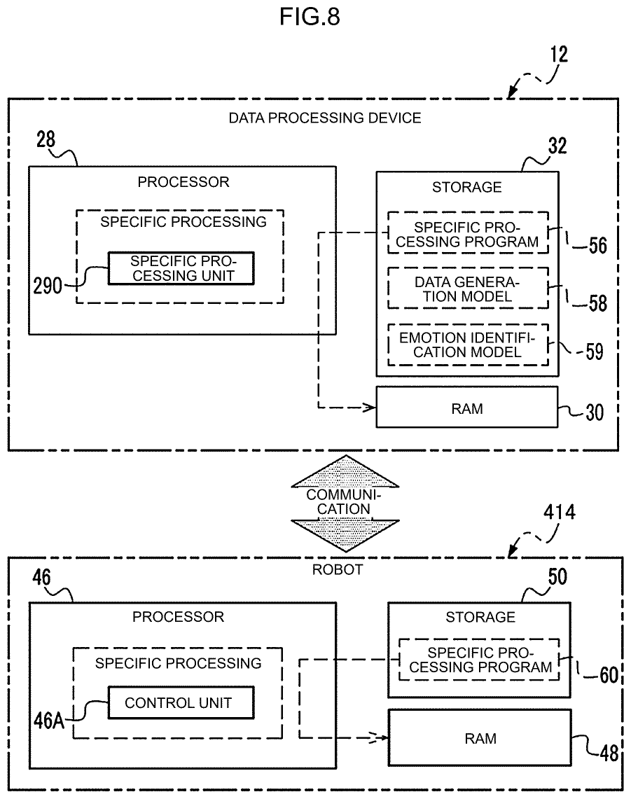

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

The correspondence between each unit and the devices or control units is not limited to the above-described examples, and various modifications are possible.

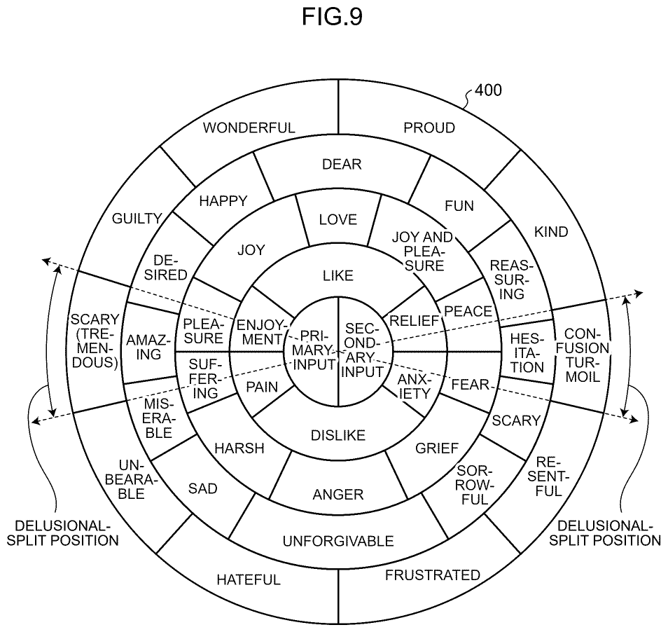

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o′clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

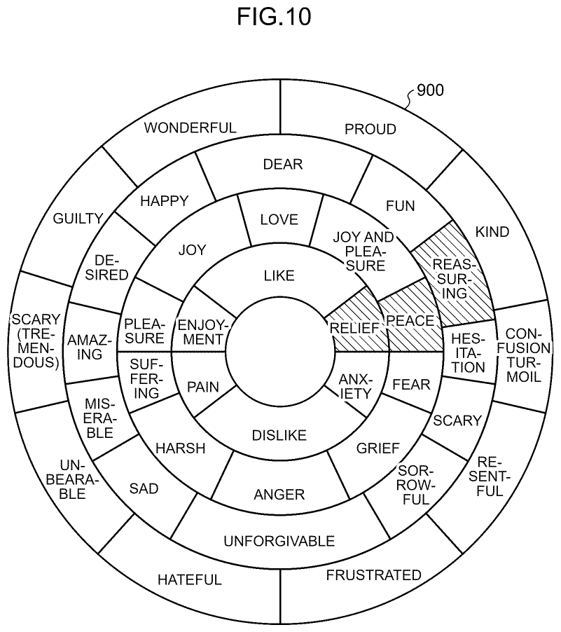

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above.

Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: an activation unit that activates a drone; a data collection unit that processes data collected by the drone activated by the activation unit; an analysis unit that analyzes the data collected by the data collection unit; and a visualization unit that visualizes the data analyzed by the analysis unit.

2. The system according to claim 1, wherein the activation unit simultaneously activates a plurality of drones within one hour after the occurrence of a disaster.

3. The system according to claim 1, wherein the data collection unit captures images of the damage situation using a drone equipped with a camera.

4. The system according to claim 1, wherein the analysis unit analyzes the damage situation data using generative AI.

5. The system according to claim 1, wherein the visualization unit visualizes the damage situation as a 3D map using generative AI.

6. The system according to claim 1, wherein the analysis unit rapidly processes the damage situation data.

7. The system according to claim 1, wherein the visualization unit enables real-time understanding of the damage situation at the site.

8. The system according to claim 1, wherein the activation unit estimates the user's emotion and adjusts the drone activation timing based on the estimated user emotion.
